(19) United States
(12) Patent Application Publication
(10) Pub. No.: US 2024/0242723 A1
(43) Pub. Date: Jul. 18, 2024

(54) VOICE CONTROL METHOD AND APPARATUS, COMPUTER READABLE STORAGE MEDIUM, AND ELECTRONIC DEVICE

(71) Applicant: BOE Technology Group Co., Ltd., Beijing (CN)

(72) Inventors: Zhusong YI, Beijing (CN); Yan SHEN, Beijing (CN)

(73) Assignee: BOE Technology Group Co., Ltd., Beijing (CN)

(21) Appl. No.: 18/562,356

(22) PCT Filed: Mar. 30, 2022
(86) PCT No.: PCT/CN2022/084182

§ 371 Date: Nov. 20, 2023

(51) Int. Cl. G10L 17/22; G10L 17/02; G10L 17/04

(52) U.S. Cl. CPC G10L 17/22; G10L 17/02; G10L 17/04

(57) ABSTRACT

A voice control method and apparatus, a readable storage medium, and an electronic device, relating to the technical field of voice control. The method comprises: acquiring user voice information, and creating a voice control relationship between a user and a target voice control window on the basis of the user voice information, wherein the target voice control window is one of a plurality of voice control windows displayed in a display terminal; and converting the user voice information into a control instruction, and executing control content corresponding to the control instruction in the target voice control window.

### CROSS-REFERENCE TO RELATED APPLICATION

The present application is based upon International Application No. PCT/CN2022/084182, filed on Mar. 30, 2022, and the entire contents thereof are incorporated herein by reference.

### TECHNICAL FIELD

The present disclosure relates to the field of voice control technology, and in particular, to a voice control method and voice control apparatus, computer-readable storage media and electronic device.

### BACKGROUND

With the development of voice control technology and terminal device, users can control the terminal through voice.

It should be noted that the information disclosed in the above background section is only used to enhance understanding of the background of the present disclosure, and therefore may include information that does not constitute prior art known to those of ordinary skill in the art.

### SUMMARY

The objective of this disclosure is to provide a voice control method, a voice control device, a computer-readable storage medium and an electronic device.

Additional features and advantages of the disclosure will be apparent from the following detailed description, or, in part, may be learned by practice of the disclosure.

According to a first aspect of an embodiment of the present disclosure, a voice control method is provided for use in a display terminal. The method includes: obtaining user voice information, and creating a voice control relationship between the user and a target voice control window based on the user voice information; wherein the target voice control window is one of multiple voice control windows displayed in the display terminal; and converting the user voice information into a control instruction, and executing control content corresponding to the control instruction in the target voice control window.

In an exemplary embodiment of the present disclosure, the creating the voice control relationship between the user and the target voice control window based on the user voice information, includes: determining voice features corresponding to the user voice information, and determining a number N of users based on the voice features; in a case that the number N of users is less than or equal to a preset number M, displaying N voice control windows in the display terminal; and creating the voice control relationship between the N users and the N voice control windows, respectively.

In an exemplary embodiment of the present disclosure, the preset number M is determined based on a size of the display terminal or a target size corresponding to the display terminal.

In an exemplary embodiment of the present disclosure, the method further includes: in a case that the number N of users is greater than the preset number M, selecting, from the N users, M target users according to a preset rule, wherein the preset rule includes: detecting a distance between the user and the display terminal, and selecting the M target users from the N users according to the distance; or, selecting the M target users from the N users according to the voice features, wherein the voice features includes volume; and creating the voice control relationship between the M target users and the M voice control windows, respectively.

In an exemplary embodiment of the present disclosure, the method further includes: in a case that the number N of users is less than or equal to the preset number M, obtaining relative position information of the users relative to the display terminal; and creating, according to the relative position information, the voice control relationship between the N users and the N voice control windows, respectively.

In an exemplary embodiment of the present disclosure, the creating the voice control relationship between the user and the target voice control window based on the user voice information, includes: displaying M voice control windows in the display terminal, and assigning a window identifier to each voice control window; in a case that the user voice information includes information matching the window identifier, determining the target voice control window from the M voice control windows according to the user voice information; and creating the voice control relationship between the user corresponding to the user voice information and the target voice control window.

In an exemplary embodiment of the present disclosure, the information matching the window identifier includes position information of the user; and the determining the target voice control window from the M voice control windows according to the user voice information, includes: determining the target voice control window from the M voice control windows according to the position information.

In an exemplary embodiment of the present disclosure, the method further includes: in a case that the user voice information does not includes information matching the window identifier, obtaining relative position information of the user relative to the display terminal; and creating the voice control relationship between the user corresponding to the user voice information and the target voice control window according to the relative position information.

In an exemplary embodiment of the present disclosure, the creating the voice control relationship between the user and the target voice control window based on the user voice information, includes: displaying M voice control windows in the display terminal; determining preset voiceprint information corresponding to the M voice control windows respectively; performing voiceprint recognition on the user voice information to obtain user voiceprint information, and in a case that the user voiceprint information matching preset voiceprint information, determining the voice control window corresponding to the preset voiceprint information as the target voice control window; and creating the voice control relationship between the user corresponding to the user voiceprint information and the target voice control window.

In an exemplary embodiment of the present disclosure, the obtaining user voice information includes: obtaining original user voice information, and decoding the original user voice information to obtain user voice audio; and performing text recognition on the user voice audio to obtain the user voice information.

In an exemplary embodiment of the present disclosure, the control instruction includes an execution action and execution content; and the executing the control content corresponding to the control instruction in the target voice control window, includes: executing the execution content in the target voice control window based on the execution action.

In an exemplary embodiment of the present disclosure, the method further includes: in a case that the user voice information corresponding to the user is not obtained within a preset time period, displaying default content in the target voice control window.

In an exemplary embodiment of the present disclosure, the user voice information includes near-field voice information and/or far-field voice information.

According to a second aspect of an embodiment of the present disclosure, a voice control apparatus applied in a display terminal is provided, the voice control apparatus includes: a creating module, configured to obtain user voice information, and create a voice control relationship between the user and a target voice control window based on the user voice information, wherein the target voice control window is one of multiple voice control windows displayed in the display terminal; and an execution module, configured to convert the user voice information into a control instruction, and execute control content corresponding to the control instruction in the target voice control window.

According to a third aspect of an embodiment of the present disclosure, an electronic device is provided, including: a processor and a memory; wherein computer readable instructions are stored on the memory, and when the computer readable instructions are executed by the processor, the above voice control method of any exemplary embodiment is implemented.

According to a fourth aspect of an embodiment of the present disclosure, there is provided a computer-readable storage medium on which a computer program is stored, and when the computer program is executed by a processor, the voice control method in any of the above exemplary embodiments is implemented.

It should be understood that the foregoing general description and the following detailed description are exemplary and explanatory only, and do not limit the present disclosure.

### BRIEF DESCRIPTION OF THE DRAWINGS

The accompanying drawings, which are incorporated in and constitute a part of this specification, illustrate embodiments consistent with the disclosure and together with the description, serve to explain the principles of the disclosure. Obviously, the drawings in the following description are only some embodiments of the present disclosure. For those of ordinary skill in the art, other drawings can be obtained based on these drawings without exerting creative efforts.

FIG. 1 shows a schematic diagram of a user performing voice control on a window in the related technologies;

FIG. 2 schematically shows a flow chart of a voice control method in an embodiment of the present disclosure;

FIG. 3 schematically shows a flow chart of creating a voice control relationship between a user and a target voice control window in the voice control method in an embodiment of the present disclosure;

FIG. 4 schematically shows a schematic diagram of multiple user performing voice control on multiple voice control windows in the voice control method in an embodiment of the present disclosure;

FIG. 5 schematically shows a flow chart of creating a voice control relationship between a target user and a target voice control window in the voice control method in an embodiment of the present disclosure;

FIG. 6 schematically shows a flow chart of creating a voice control relationship between a user and a voice control window in the voice control method in an embodiment of the present disclosure;

FIG. 7 schematically shows a flow chart of creating a voice control relationship between the user and the target voice control window in the voice control method in the embodiment of the present disclosure;

FIG. 8 schematically shows a flow chart of creating a voice control relationship between the user and the target voice control window in the voice control method in the embodiment of the present disclosure;

FIG. 9 schematically shows a flow chart of creating a voice control relationship between the user and the target voice control window in the voice control method in the embodiment of the present disclosure;

FIG. 10 schematically shows a flow chart of obtaining user voice information in the voice control method in an embodiment of the present disclosure;

FIG. 11 schematically shows a flow chart of obtaining user voice information in the voice control method in an embodiment of the present disclosure;

FIG. 12 schematically shows a flow chart of a voice control method in an application scenario;

FIG. 13 schematically shows a structural diagram of a voice control apparatus in an embodiment of the present disclosure;

FIG. 14 schematically shows an electronic device used for a voice control method in an embodiment of the present disclosure; and

FIG. 15 schematically illustrates a computer-readable storage medium used for a voice control method in an embodiment of the present disclosure.

### DETAILED DESCRIPTION

Example embodiments will now be described more fully with reference to the accompanying drawings. Example embodiments may, however, be embodied in various forms and should not be construed as limited to the examples set forth herein; rather, these embodiments are provided so that this disclosure will be thorough and complete, and will fully convey the concepts of the example embodiments to those skilled in the art. The described features, structures or features may be combined in any suitable manner in one or more embodiments. In the following description, numerous specific details are provided to provide a thorough understanding of embodiments of the disclosure. However, those skilled in the art will appreciate that the technical solutions of the present disclosure may be practiced without one or more of the specific details described, or other methods, components, devices, steps, etc. may be adopted. In other instances, well-known technical solutions have not been shown or described in detail to avoid obscuring aspects of the disclosure.

The terms “a”, “an”, “the” and “said” are used in this specification to indicate the existence of one or more elements/components/etc.; the terms “include” and “have” are used to indicate an open-ended inclusive, and means that there may be additional elements/components/etc. in addition to the listed elements/components/etc.; the terms “first” and “second” etc. are used as labels only and are not limitation of the number of its objects.

Furthermore, the drawings are merely schematic illustrations of the present disclosure and are not necessarily drawn to scale. The same reference numerals in the drawings represent the same or similar parts, and thus their repeated description will be omitted. Some of the block diagrams shown in the figures are functional entities and do not necessarily correspond to physically or logically separate entities.

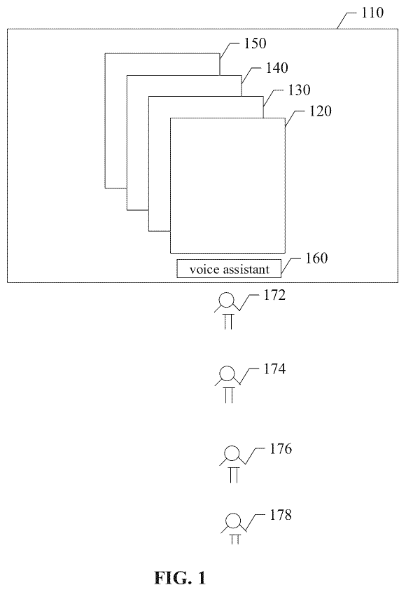

FIG. 1 shows a schematic diagram of a user performing voice control on a window in the related art. As shown in FIG. 1, the terminal 110 is a display terminal, and window 120, window 130, window 140 and window 150 are controlled windows, object 172, object 174, object 176 and object 178 are users. It is worth mentioning that currently, the user 172 realizes the registration and binding of user 172 through the voice assistant tool 160, and then at this time the user 172 can perform voice control on window 120. When the user 174 wants to perform voice control, he first needs to stop the user 172's voice control of window 120, close the window 120, and then display the window 130 in the display terminal 110, so that the user 174 can perform voice control on the window 130. When the user 176 or the user 178 wants to perform voice control, the process is similar to the above. Obviously, in the related technology, at the same moment, only one window is displayed in the display terminal 110, which reduces the screen utilization. In addition, it is impossible for multiple users to perform voice control on multiple windows respectively, and it cannot meet the voice control needs of multiple users.

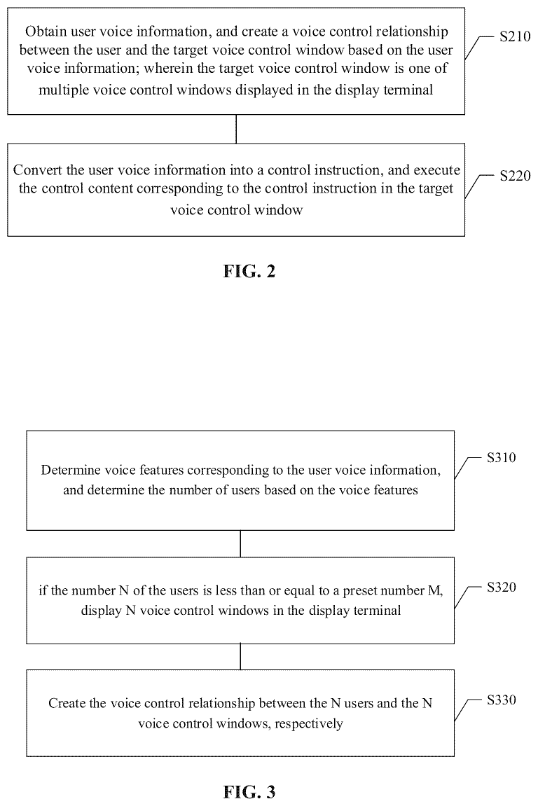

In view of the problems existing in related technologies, the present disclosure proposes a voice control method. FIG. 2 shows a schematic flow chart of a voice control method, applied in a display terminal. As shown in FIG. 2, the voice control method at least includes the followings.

Step S210. Obtain user voice information, and create a voice control relationship between the user and the target voice control window based on the user voice information; wherein the target voice control window is one of multiple voice control windows displayed in the display terminal.

Step S220. Convert the user voice information into a control instruction, and execute the control content corresponding to the control instruction in the target voice control window.

In the methods and devices provided by exemplary embodiments of the present disclosure, the display terminal can split the display window into different control windows according to needs, create a voice control relationship between the user and the target voice control window, and the target voice control window is one of multiple voice control windows in the display terminal. On the one hand, it avoids the situation in the prior art that only one voice control window is displayed in the terminal and improves screen utilization; on the other hand, according to the voice control relationship, multiple users can control multiple target voice control windows respectively, meeting the voice control needs of multiple users for the terminal.

Hereinafter, respective steps of the voice control method are explained in detail.

In step S210, user voice information is collected, and a voice control relationship between the user and the target voice control window is created based on the user voice information; where the target voice control window is one of multiple voice control windows displayed in the display terminal.

In the exemplary embodiment of the present disclosure, the display terminal refers to a terminal with a large-size screen. Generally speaking, the display terminal can be displayed in exhibition halls, counters, marketing departments, etc., and the size of the display terminal is much larger than the size of the terminal that can be used by one person, for example, the 135-inch terminal has been produced so far.

The user voice information refers to the voice information issued by the user and obtained by the display terminal. Specifically, it should be noted that the user voice information can be the voice information of one user or the voice information of multiple users, which is not specially limited by this exemplary implementation.

In the display terminal, the display terminal can be controlled to split the display area into multiple voice control windows according to the user needs. These voice control windows can be controlled by the user through voice. The target voice control window refers to one of the multiple voice control windows, and based on the collected user voice information, a voice control relationship between the user and the target voice control window can be created, and then the user can perform voice control on the target voice control window through voice at this moment.

For example, the user voice information is obtained, including “play cartoon a in window 1” issued by user A and “play music b in window 2” issued by user B. Based on this, the voice control relationship between the user A and the target voice control window 1 is created, and the voice control relationship between the user B and the target voice control window 2 may also be created. Alternatively, when the user A is using the display terminal to play content a, and the display terminal is displaying/playing in full screen, and when the user B issues a playback instruction, the display terminal splits the display screen into two parts according to the obtained control instructions, wherein one part displays/plays a, and the other part plays b.

In this exemplary embodiment, the user voice information includes near-field voice information and/or far-field voice information.

In the embodiment, the near-field voice information is the user voice information corresponding to the original user voice information collected by the voice-collecting device when the user is close to the voice-collecting device. In addition, under normal circumstances, the near-field voice information can be obtained by the collection using the microphone array in the handheld Bluetooth remote control, and when the user is close to the display terminal, the near-field voice information can also be collected by the microphone array in the display terminal.

The Bluetooth remote control needs to be bound to the display terminal, so that the original user voice information of the user close to the display terminal can be obtained, and then the original user voice information can be processed to obtain the near-field voice information.

The far-field voice information is the user voice information corresponding to the original user voice information obtained using the built-in microphone array of the display terminal. The original user voice information obtained using the microphone array is the information generated by the users relatively far away from the display terminal, and then the user voice information may be obtained by processing the original user voice information.

It is worth noting that under normal circumstances, the display terminal device can obtain the near-field voice information and the far-field voice information at the same time, or it can only obtain the near-field voice information, or it can only obtain the far-field voice information, which is not specially limited by this exemplary embodiment.

For example, the obtained user voice information includes near-field voice information of a user positioned close to the display terminal, and the obtained user voice information also includes far-field voice information of a user positioned far away from the display terminal.

In this exemplary embodiment, the obtained user voice information may include both the near-field voice information and the far-field voice information, or may only include any one of the near-field voice information and the far-field voice information. On the one hand, it improves the logic of obtaining user voice information, and on the other hand, it meets different obtaining needs.

In an optional embodiment, FIG. 3 shows a schematic flow chart of creating a voice control relationship between the user and the target voice control window in the voice control method. As shown in FIG. 3, the method at least includes the following steps: in step S310, the voice features corresponding to the user voice information are determined, and the number of users is determined based on the voice features.

In the embodiment, the voice feature is the feature related to the user voice information. Specifically, the voice feature can be the timbre corresponding to the user voice information, the user voiceprint information corresponding to the user voice information, or the volume corresponding to the user voice information, or the uninterrupted time corresponding to the user voice information. This exemplary embodiment does not specifically limit this. Based on this, by distinguishing the voice features, the number of different voice features can be determined, and then, the number of different voice features that exist indicates the number of users who need voice control.

For example, after collecting user voice information X, it is determined that the user voice information X has three timbres, and then it is determined that the user voice information X is issued by 3 users, i.e., the number of the users is 3.

In step S320, if the number N of the users is less than or equal to a preset number M, N voice control windows are displayed in the display terminal.

In the embodiment, the preset number is the maximum number of voice control windows that can be displayed in the display terminal. When the number of users is less than the preset number, the display terminal can display voice control windows consistent with the number of users. Also, the window registration module in the display terminal can register the voice control windows of the same number of the number of users to the voice assistant using the corresponding window registration function, thereby allowing the voice assistant to know which windows displayed in the terminal are voice control windows, to facilitate subsequent voice control of the voice control window.

For example, the number of users is 3 and the preset number is 4. Obviously, the number of users is less than the preset number at this time, and 3 voice control windows can be displayed on the display terminal.

In step S330, the voice control relationship between the N users and the N voice control windows is created, respectively.

In the embodiment, based on the above steps, the voice control relationship between the N users and the N voice control windows can be created, respectively.

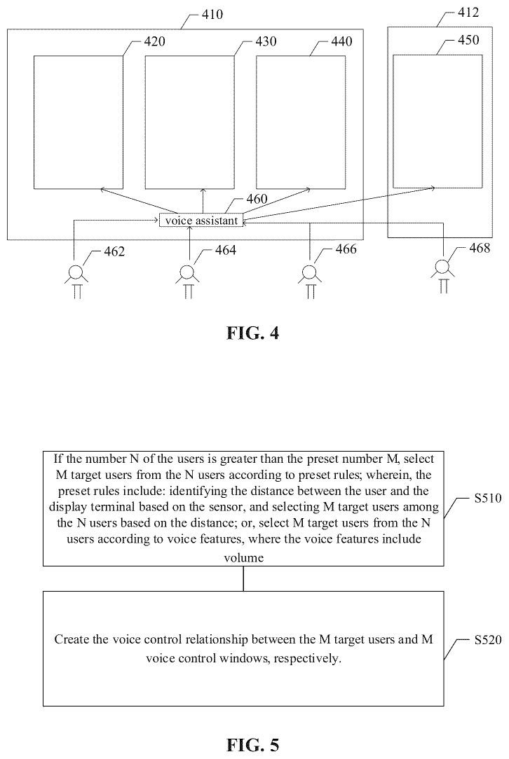

For example, FIG. 4 shows a schematic diagram of multiple users performing voice control on multiple voice control windows. As shown in FIG. 4, screen 410 is the main screen of the display terminal, and screens 412 is the side screen of the display terminal. The window 420, window 430, window 440 and window 450 are voice control windows, the object 462, object 464, object 466 and object 468 are users, the tool 460 is a voice assistant, and the voice assistant determines and the voice features corresponding to the user voice information and creates a voice control relationship between the user 462 and the voice control window 420, and also creates a voice control relationship between the user 464 and the voice control window 430, and also creates a voice control relationship between the user 466 and the voice control window 430, and also creates a voice control relationship between the user 468 and the voice control window 440.

In the present exemplary embodiment, if the number N of the users is smaller than or equal to the present number M, N voice control windows are displayed in the display terminal, and the voice control relationship between the N users and the N voice control windows is created, respectively, thereby achieving the process of dynamically displaying the voice control window according to the number of users, which not only avoids the situation in the existing technology that a terminal can only display one voice control window at the same time, but also improves the flexibility of displaying the voice control window.

In this exemplary embodiment, the preset number is determined according to the size of the display terminal or a target size corresponding to the display terminal.

The size of the display terminal is the size of the display terminal screen. The target size corresponding to the display terminal may be the optimal display size of the display terminal. For example, the size of the display terminal is the size X of the display terminal screen. Since the size X is very large, and size Y can be used as the optimal size corresponding to the display terminal, that is, size Y is the target size corresponding to the display terminal.

Based on this, different display terminals have different sizes. Therefore, the number of voice control windows displayed on the display terminal can be determined according to the different sizes. This number is the preset number. Similarly, according to different target sizes, the number of voice control windows displayed on the display terminal can be determined, and the number is also the preset number.

If the screen size of the display terminal is X, the number of voice control windows displayed on the display terminal can be determined to be 4 according to the size of the display terminal.

In this exemplary embodiment, the preset number may be determined based on the size of the display terminal, or may be determined based on the target size corresponding to the display terminal, thereby meeting the splitting requirements of different display terminals and improving the flexibility in determining the number of voice control windows displayed in the display terminal.

In this exemplary embodiment, FIG. 5 shows a schematic flowchart of creating a voice control relationship between the target user and the voice control window in the voice control method. As shown in FIG. 5, the method at least includes the following steps: in step S510, if the number N of the users is greater than the preset number M, M target users are selected from the N users according to preset rules; wherein, the preset rules include: identifying the distance between the user and the display terminal based on the sensor, and selecting M target users among the N users based on the distance. Alternatively, the M target users are selected among the N users based on voice features, where the voice features include volume.

In the embodiment, when the number of users is greater than the preset number, M target users need to be determined among the N users according to the preset rules. Specifically, the preset rules include two rules. In the first preset rule, the distance between the user and the display terminal is identified by the sensor, and M target users are selected from the N users based on the distance.

For example, the number of users is 4 and the preset number is 3. Obviously, at this time, the number of users is greater than the preset number, and the distances between the 4 users and the display terminal are obtained by the sensor. Specifically, the distance between the user A and the display terminal is 1 meter, the distance between the user B and the display terminal is 0.5 meters, the distance between the user C and the display terminal is 0.4 meters, and the distance between the user D and the display terminal is 0.75 meters. Obviously, the user A is the farthest from the display terminal, and the three target users identified are user B, user C, and user D.

In the second preset rule, M users can be selected among the N users based on volume.

For example, the number of users is 5 and the preset number is 3. Obviously, at this time, the number of users is greater than the preset number, and the volumes corresponding to 5 users are obtained. Specifically, the volume corresponding to the user A is 100 dB, the volume corresponding to the user B is 120 dB, the volume corresponding to the user C is 150 dB, the volume corresponding to the user D is 155 dB, and the volume corresponding to the user E is 200 dB. Based on this, among the 5 users, the selected target users are user E, user D, and user C.

In step S520, the voice control relationship between the M target users and M voice control windows is created, respectively.

In the embodiment, based on the above preset rules, a voice control relationship between the target user and the voice control window is established.

For example, the target users are user B, user C and user D, and based on this, the voice control relationship between the user B and the voice control window 1 can be created, the voice control relationship between the user C and the voice control window 2 can also be created, and the voice control relationship between the user C and the voice control window 3 can also be created.

In this exemplary embodiment, when the number N of the users is greater than the preset number M, M target users can be selected from the N users based on the distance between the users and the display terminal, or M target users can be selected from the N users based on the volume, which improves the logic of subsequent creation of the voice control relationship between the target user and the voice control window, and avoids the situation where the voice control relationship between the user and the voice control window cannot be created when the number of users is greater than the preset number.

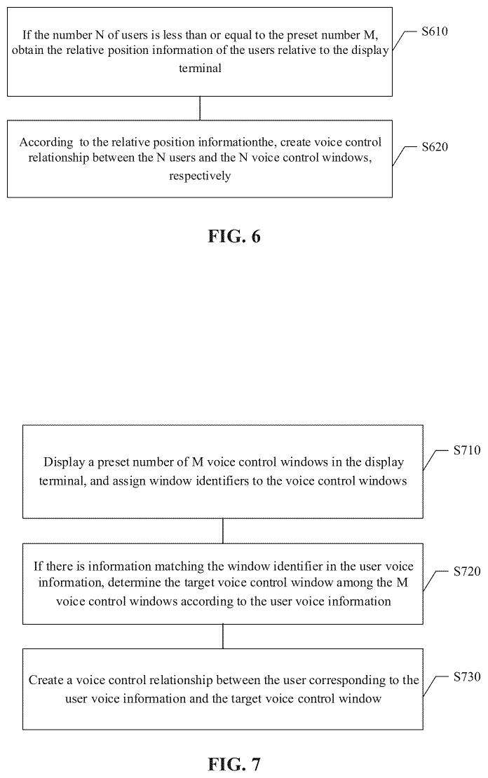

In this exemplary embodiment, FIG. 6 shows a schematic flowchart of creating a voice control relationship between the user and the voice control window in the voice control method. As shown in FIG. 6, the method at least includes the following steps: in step S610, if the number N of users is less than or equal to the preset number M, the relative position information of the users relative to the display terminal is obtained.

In the embodiment, when the number N of the users is less than the preset number M, the voice control relationship between the user and the voice control window can also be accurately created based on the relative position information. The relative position information is the position information of the user relative to the display terminal, for example, if the user is close to the left side of the display terminal, the relative position information is left.

For example, the number of users is 3 and the preset number is 4. Obviously, at this time, the number of users is less than the preset number. Then the relative position information left of the user A relative to the display terminal is obtained, the relative position information middle of the user B relative to the display terminal is obtained, and relative position information right of the user C relative to the display terminal is obtained.

In step S620, the voice control relationship between the N users and the N voice control windows are created respectively according to the relative position information.

In the embodiment, based on the relative position information, the voice control relationship between the N users and the N voice control windows are created, respectively.

For example, the number of users is 3 and the preset number is 4. Obviously, at this time, the number of users is less than the preset number. Then the relative position information of the user A relative to the display terminal is obtained as left, the relative position information of the user B relative to the display terminal is obtained as middle, and the relative position information of the user C relative to the display terminal is obtained as right.

Based on this, a voice control relationship is created between the user A and the voice control window on the left, a voice control relationship is created between the user B and the voice control window in the middle, and a voice control relationship is created between the user C and the voice control window on the right.

In this exemplary embodiment, based on the relative position information, voice control relationships between N users and N voice control windows are created, which prevents the user from moving the position, improves the user experience, and further improves the voice control efficiency.

In an optional embodiment, FIG. 7 shows a schematic flowchart of creating a voice control relationship between the user and the target voice control window in the voice control method. As shown in FIG. 7, the method at least includes the following steps: in step S710, a preset number of M voice control windows are displayed in the display terminal, and window identifiers are assigned to the voice control windows.

The window identification is the identification information assigned by the voice assistant to the voice control window after the M voice control windows are registered to the voice assistant through the voice registration module in the display terminal. Specifically, the window identification can be a number, or may be a string of characters, a paragraph of text, or the user's position identifier, which is not specifically limited in this exemplary embodiment.

For example, the default number is 4. These 4 voice control windows are registered into the voice assistant using the window registration module. After the registration is completed, the voice assistant will assign corresponding window identifiers to these 4 voice control windows.

In step S720, if there is information matching the window identifier in the user voice information, the target voice control window is determined among the M voice control windows according to the user voice information.

In the embodiment, if there is information matching the window identifier in the user voice information, it indicates that the user needs to control the voice control window corresponding to the window identifier at this time. Furthermore, the target voice control window corresponding to the window ID among the M voice control windows can be determined based on the user's voice.

For example, the user voice information is “play music A in window 1”. At this time, there is information matching the window identifier “window 1” in the user voice information. Then the voice control window corresponding to the window identifier “window 1” is determined among the four voice control windows as the target voice control window.

In step S730, a voice control relationship between the user corresponding to the user voice information and the target voice control window is created.

In the embodiment, after the target voice control window is determined, a voice control relationship between the user who generated the user voice information and the target voice control window can be created.

For example, the user who sends the user voice information “play music A in window 1” is XX, and the target voice control window is window 1, thereby creating a voice control relationship between the user XX and the window 1.

For example, there are three customers who send user voice information, namely customer a, customer b, and customer c. The user voice information sent by customer a is “play movie in window 1”, and the user voice information sent by customer b is “open browser in window 2”, and the user voice information sent by client c is “play music in window c”. At this time, a voice control relationship between client a and window 1 is created, also, a voice control relationship between client b and window 2 is also created, also, a voice control relationship between client c and window 3 is also create.

In this exemplary embodiment, if there is information matching the window identifier in the user voice information, the target voice control window is determined based on the user voice information, and then a voice control relationship is created between the user corresponding to the user voice information and the target voice control window, which provides a way to create a voice control relationship based on the window identifier, which avoids the situation in the existing technology that a terminal can only display one voice control window at the same time.

In an optional embodiment, the information matching the window identifier includes user position information, and the determining the target voice control window in the M voice control windows based on the user voice information includes: based on the position information, determining the target voice control window from the M voice control windows.

In the embodiment, the window identifier includes a position identifier, and the position information is the information corresponding to the position identifier, which is used to indicate the position of the user, and then the target voice control window can be determined among the M voice control windows based on the position information.

For example, there are three users. The window ID corresponding to user 1 is 1010, and then it is determined that the position information matching the window ID 1010 is (10, 10); the window ID corresponding to user 2 is 5025, and then it is determined that the position information matching the window ID 5025 is (50, 25); and the window ID corresponding to user 3 is 7020, and then it is determined that the position information matching the window ID 7020 is (70, 20). Then, the three target voice control windows are determined among the M voice control windows, and these three target voice control windows are respectively facing the position information of the above three users.

In this exemplary embodiment, the target control window is determined among the M voice control windows based on the position information, which provides a more accurate method of determining the target control window, thereby improving the user experience.

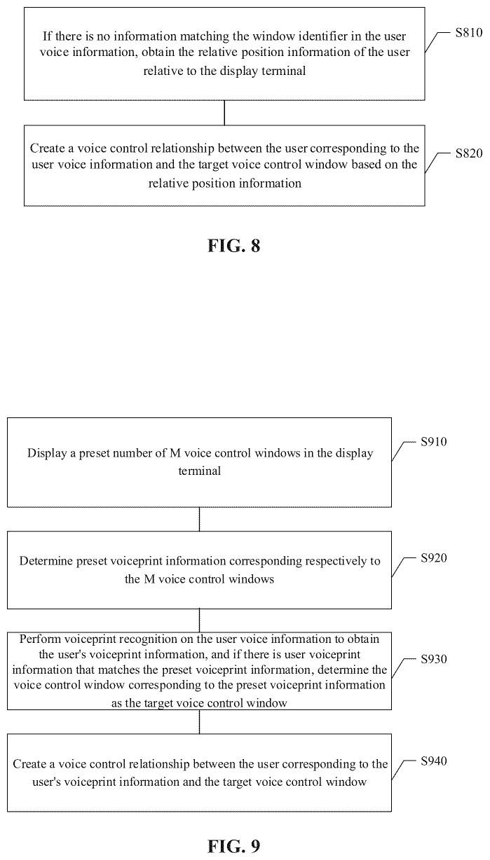

In an optional embodiment, FIG. 8 shows a schematic flowchart of creating a voice control relationship between the user and the target voice control window in the voice control method. As shown in FIG. 8, the method at least includes the following steps: in step S810, if there is no information matching the window identifier in the user voice information, the relative position information of the user relative to the display terminal is obtained.

In the embodiment, if there is no information matching the window identifier in the user voice information, the sensor can be used to obtain the relative position information of the user relative to the display terminal. For example, the relative position information of the user relative to the display terminal is obtained to be left.

In step S820, a voice control relationship between the user corresponding to the user voice information and the target voice control window is created based on the relative position information.

In the embodiment, a voice control relationship between the user and the target voice control window is created based on the obtained relative position information.

For example, the user voice information of two users is collected, and there is no information matching the window identifier in the voice information of the two users. The relative position information of user 1 relative to the display terminal is obtained using sensors as left, and the relative position information of user 2 relative to the display terminal is obtained as right. Based on this, a voice control relationship is created between the user 1 and the target voice control window A displayed on the left side of the display terminal, and a voice control relationship between the user 2 and the target voice control window B displayed on the right side of the display terminal is created.

In this exemplary embodiment, when there is no information matching the window identifier, a voice control relationship between the user and the target voice control window is created based on the relative position information, which improves the logic of creating a voice control relationship and avoids the case that the voice control relationship cannot be created when there is no information matching the window identifier.

In an optional embodiment, FIG. 9 shows a schematic flowchart of creating a voice control relationship between the user and the target voice control window in the voice control method. As shown in FIG. 9, the method at least includes the following steps: in step S910, a preset number of M voice control windows are displayed in the display terminal.

In the embodiment, M voice control windows are displayed in the display terminal based on the preset number M. For example, the preset number is 5. Based on this, 5 voice control windows can be displayed in the display terminal.

In step S920, preset voiceprint information corresponding respectively to the M voice control windows is determined.

The preset voiceprint information is the voiceprint information that is preset to have a voice control relationship with the voice control window. For example, the preset voiceprint information includes voiceprint information A, voiceprint information B, and voiceprint information C, wherein, the voiceprint information A has a voice control relationship with the voice control window a, the voiceprint information B has a voice control relationship with the voice control window a, and the voiceprint information C has a voice control relationship with the voice control window b. Then, the user that can sent the voice with the same preset voiceprint information may perform control on the corresponding voice control window.

For example, five voice control windows are displayed in the display terminal. Furthermore, the preset voiceprint information XX-1 corresponding to the first voice control window can be determined, the preset voiceprint information XX-2 corresponding to the second voice control window can also be determined, the preset voiceprint information XX-3 corresponding to the third voice control window can also be determined, the preset voiceprint information XX-4 corresponding to the fourth voice control window can also be determined, and the preset voiceprint information XX-5 corresponding to the fifth voice control window can also be determined.

In step S930, perform voiceprint recognition on the user voice information to obtain the user's voiceprint information. If there is user voiceprint information that matches the preset voiceprint information, determine the voice control window corresponding to the preset voiceprint information as the target voice control window.

In the embodiment, the user voiceprint information is the identified voiceprint information corresponding to the user voice information. If there is user voiceprint information that matches the preset voiceprint information, it indicates that the user voice information includes information that can control a certain voice control window, and then the voice control window corresponding to the preset voiceprint information that matches the user voice information is determined, and the window is used as the target voice control window.

For example, voiceprint recognition is performed on the user voice information to obtain the user's voiceprint information XX-1, and at this time there is preset voiceprint information XX-1 that matches the user's voiceprint information XX-1, and then the first voice control window corresponding to the preset voiceprint information XX-1 among the 5 voice control windows is determined as the target voice control window.

In step S940, a voice control relationship between the user corresponding to the user's voiceprint information and the target voice control window is created.

Based on the above steps, a voice control relationship is created between the user and the target voice control window, and the user is the user corresponding to the user's voiceprint information.

For example, the user corresponding to the user's voiceprint information is the user 3, and the target voice control window is the window 2, then a voice control relationship between the user 3 and the window 2 is created.

In this exemplary embodiment, if there is user voiceprint information matching the preset voiceprint information, the voice control window corresponding to the preset voiceprint information is determined to be the target voice control window, and then the voice control relationship between the user and the target voice control windows is created, which avoids the situation in the existing technology that a terminal can only display one voice control window at the same time.

In step S120, the user voice information is converted into a control instruction, and the control content corresponding to the control instruction is executed in the target voice control window.

In the method and device provided by the exemplary embodiments of the present disclosure, the control instruction is an instruction to control the target voice control window to execute the control content. The control content can be a song, a movie, or a text, this exemplary embodiment does not specifically limit this.

For example, the user voice information “play movie Kung Fu Panda in window 1” is converted into a control instruction “Window1_play_KungFuPanda”, and the control instruction is sent to the scene execution module, then the scene execution module plays the movie “Kung Fu Panda” in the target voice control window.

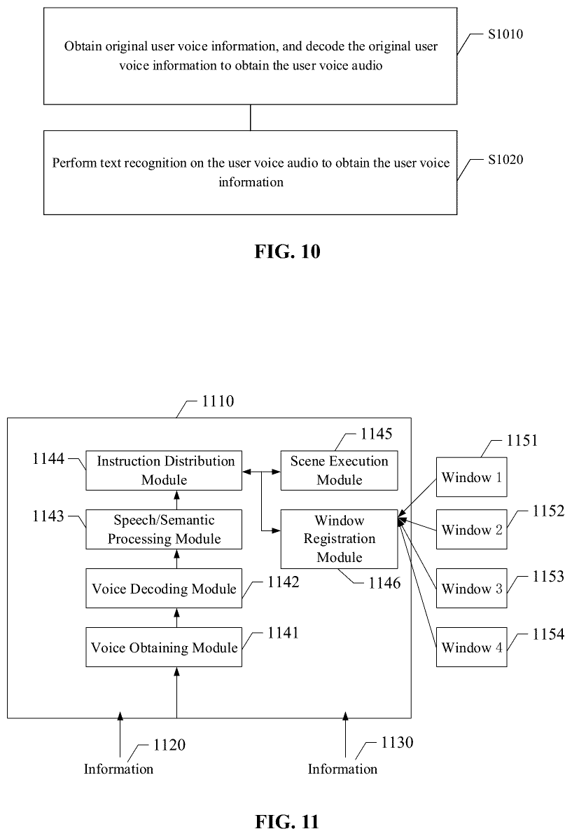

In an optional embodiment, FIG. 10 shows a schematic flow chart of obtaining user voice information in the voice control method. As shown in FIG. 10, the method at least includes the following steps: In step S1010, obtain original user voice information, and decode the original user voice information to obtain the user voice audio.

In the embodiment, the original user voice information is a piece of coded information. The original user voice information can be decoded using the voice decoding module in the display terminal to obtain the user voice audio.

For example, the original user voice information obtained is XXXXX, and the voice decoding module is used to decode the user voice information to obtain the user voice audio in audio format.

In step S1020, text recognition is performed on the user voice audio to obtain the user voice information.

After obtaining the user voice audio, the speech/semantic processing module in the display terminal can also be used to perform text recognition on the user voice audio to obtain the user voice information in text format.

For example, after obtaining the user voice audio, the speech/semantic processing module is used to perform text recognition on the user voice audio to obtain the user voice information in text format.

Specifically, FIG. 11 schematically shows a flow chart for obtaining user voice information. As shown in FIG. 11, tool 1110 is a voice assistant, information 1120 is near-field voice information, information 1130 is far-field voice information, and module 1141 is a voice obtaining module, used to obtain the original user voice information corresponding to the near and field voice information and/or the original user voice information corresponding to the far-field voice information. The module 1142 is a voice decoding module, used to decode the original user voice information to obtain the user voice audio. The module 1143 is a speech/semantic processing module, which is used to perform text recognition on the user voice audio to obtain user voice information. The module 1144 is an instruction distribution module, which is used to distribute subsequent control instructions. The module 1145 is a scene execution module, used to execute control content corresponding to the control instructions in the target voice control window. The module 1146 is a window registration module, used to register the window 1151, window 1152, window 1153 and window 1154 into the voice assistant 1110.

In this exemplary embodiment, the original user voice information is decoded to obtain the user voice audio, and text recognition is performed on the user voice audio to obtain the user voice information, which is helpful for subsequent conversion of the user voice information to obtain control instructions, thereby achieving the voice control for the voice control window.

In an optional embodiment, the control instruction includes an execution action and execution content; executing the control content corresponding to the control instruction in the target voice control window includes: executing the execution content in the target voice control window based on the execution action.

In the embodiment, the control instructions include execution actions and execution content. The execution actions can be “play”, “display”, “pause”, “fast forward”, “fast rewind”, “close”, or any action that can be performed by the target voice control window, which is not specially limited in this exemplary embodiment.

The execution content can be “video”, “audio”, “document”, “slideshow”, or any content that can be executed by the target voice control window, which is not specially limited in this exemplary embodiment.

For example, if the control instruction is “Wind owl_play_film_KungFuPanda”, then the movie Kung Fu Panda is played in the target voice control window, that is, in window 1. If the control instruction is “play_music_RiceField”, and the control instruction is obtained by converting the user voice information corresponding to user 1, while the target voice control window having a voice control relationship with the user 1 is window 2, and then the music “RiceField” may be played in the window 2.

In this exemplary embodiment, based on the execution action, the execution content is executed in the target voice control window, thereby enabling different users to perform voice control on different target voice control windows, avoiding the problem in the prior art that a user can perform voice control on only one voice control window in the terminal at a time.

In an optional embodiment, the method further includes: if the user voice information corresponding to the user is not obtained within a preset time period, displaying default content in the target voice control window.

In the embodiment, the default content is the content displayed in the target voice control window when no control instruction is received. Specifically, it can be a default background, a default picture, or a default prompt message, which is not specially limited by this exemplary embodiment.

The preset time period is a period of time. When no user voice information is received during this period of time, the target voice control window can no longer be voice controlled, and the default content can be displayed in the target voice control window, to wait for obtaining the user voice information again.

For example, the preset time period is 1 hour. If no user voice information sent by the user who has a voice control relationship with the target voice control window is obtained within 1 hour, it indicates that the user has stopped the voice control on the target voice control window, then the default content of “this window is available” is displayed in the target voice control window.

In this exemplary embodiment, if the user voice information corresponding to the user is not obtained within the preset time period, default content is displayed in the target voice control window to remind the user that the target voice control window is available.

In the method and device provided by the exemplary embodiments of the present disclosure, a voice control relationship is created between the user and the target voice control window, and the target voice control window is one of multiple voice control windows in the display terminal. On the one hand, it avoids the situation in the existing technology that only one voice control window is displayed in the terminal, and improves the screen utilization; on the other hand, according to the voice control relationship, multiple users can control multiple target voice control windows respectively, which satisfies the voice control needs of multiple users for the terminal.

Hereinafter, the present disclosure will be described in detail below in conjunction with an application scenario.

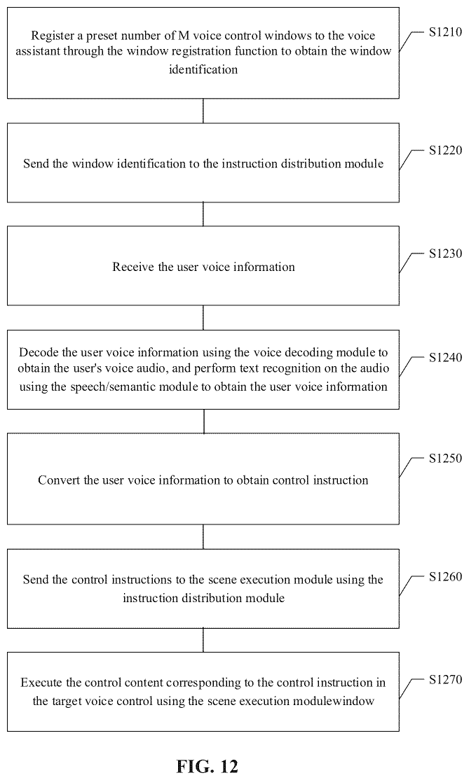

FIG. 12 schematically shows a flow chart of a voice control method in an application scenario. As shown in FIG. 12, step S1210 is to register a preset number of M voice control windows to the voice assistant through the window registration function to obtain the window identification. Step S1220 is to send the window identification to the instruction distribution module. Step S1230 is to receive the user voice information. Step S1240 is to use the voice decoding module to decode the user voice information to obtain the user's voice audio, and to use the speech/semantic module to perform text recognition on the audio to obtain the user voice information. Step S1250 is to convert the user voice information to obtain control instructions. Step S1260 is to send the control instructions to the scene execution module using the instruction distribution module. Step S1270 is to use the scene execution module to execute the control content corresponding to the control instruction in the target voice control window.

In this application scenario, a voice control relationship is created between the user and the target voice control window, and the target voice control window is one of multiple voice control windows in the display terminal. On the one hand, it avoids the situation in the existing technology that only one voice control window is displayed in the terminal, and improves the screen utilization; on the other hand, according to the voice control relationship, multiple users can control multiple target voice control windows respectively, which satisfies the voice control needs of multiple users for the terminal.

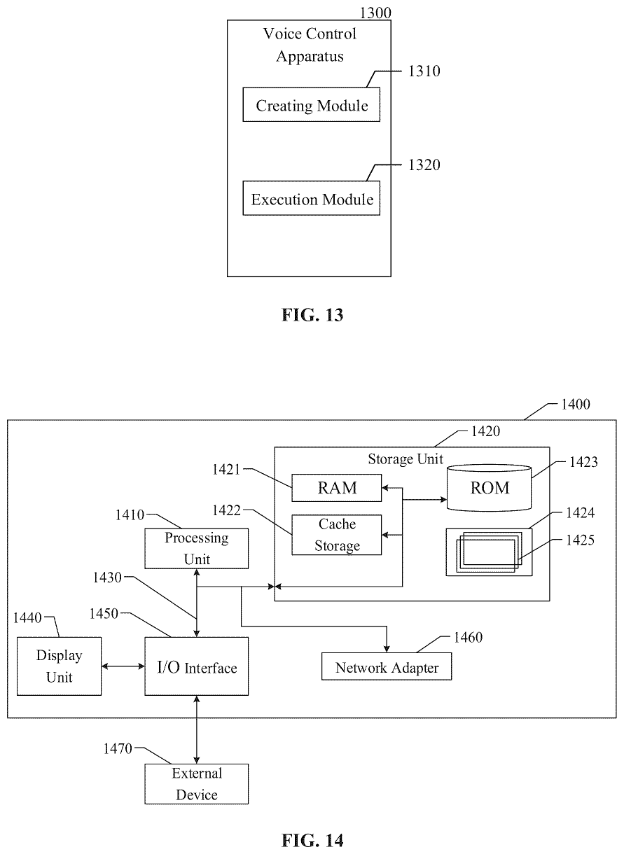

Furthermore, in an exemplary embodiment of the present disclosure, a voice control apparatus is also provided. FIG. 13 shows a schematic structural diagram of the voice control apparatus. As shown in FIG. 13, the voice control apparatus 1300 may include: a creating module 1310 and an execution module 1340.

The creating module 1310 is configured to obtain the user voice information, and create a voice control relationship between the user and the target voice control window based on the user voice information; wherein the target voice control window is one among multiple voice control windows displayed in the display terminal; and the execution module 1320 is configured to convert the user voice information into control instructions, and execute the control content corresponding to the control instructions in the target voice control window.

The specific details of the above voice control apparatus 1300 have been described in detail in the corresponding voice control method, so they will not be described again here.

It should be noted that, although serval modules or units of the voice control apparatus 1300 are mentioned in the above detailed description, this division is not mandatory. In fact, according to embodiments of the present disclosure, the features and functions of two or more modules or units described above may be embodied in one module or unit. Conversely, the features and functions of one module or unit described above may be further divided into being embodied by multiple modules or units.

Furthermore, in an exemplary embodiment of the present disclosure, an electronic device capable of implementing the above method is also provided.

An electronic device 1400 according to such an embodiment of the present disclosure is described below with reference to FIG. 14. The electronic device 1400 shown in FIG. 14 is only an example, and should not impose any limitation on the function and scope of use of the embodiments of the present disclosure.

As shown in FIG. 14, electronic device 1400 takes the form of a general-purpose computing device. Components of the electronic device 1400 may include, but are not limited to: the above-mentioned at least one processing unit 1410, the above-mentioned at least one storage unit 1420, a bus 1430 connecting different system components (including the storage unit 1420 and the processing unit 1410), and a display unit 1440.

The storage unit stores program codes that can be executed by the processing unit 1410 to cause the processing unit 1410 to perform steps of various exemplary embodiments according to the present disclosure described in the above “DETAILED DESCRIPTION” section of this specification.

The storage unit 1420 may include a readable medium in the form of a volatile storage unit, such as a random access storage unit (RAM) 1421 and/or a cache storage unit 1422, and may further include a read only storage unit (ROM) 1423.

The storage unit 1420 may also include a program/utility tool 1424 having a set (at least one) of program modules 1425, such program modules 1425 including, but not limited to: an operating system, one or more application programs, other program modules, and program data, each or some combination of these examples may contain the reality of the network environment.

The bus 1430 may be representative of one or more of several types of bus structures, including a memory cell bus or memory cell controller, a peripheral bus, an accelerated graphics port, a processing unit, or a local area bus using any of a variety of bus structures.

The electronic device 1400 may also communicate with one or more external devices 1470 (e.g., keyboards, pointing devices, Bluetooth devices, etc.), with one or more devices that enable a user to interact with the electronic device 1400, and/or with any device (e.g., router, modem, etc.) that enables the electronic device 1400 to communicate with one or more other computing devices. Such communication may be implemented through input/output (I/O) interface 1450. Also, the electronic device 1400 may communicate with one or more networks (e.g., a local area network (LAN), a wide area network (WAN), and/or a public network such as the Internet) through a network adapter 1460. As shown in the drawings, the network adapter 1460 communicates with other modules of electronic device 1400 via bus 1430. It should be appreciated that, although not shown, other hardware and/or software modules may be used in conjunction with electronic device 1400, including but not limited to: microcode, device drivers, redundant processing units, external disk drive arrays, RAID systems, tape drives and data backup storage systems.

From the description of the above embodiments, those skilled in the art can easily understand that the exemplary embodiments described herein may be implemented by software, or may be implemented by software combined with necessary hardware. Therefore, the technical solutions according to the embodiments of the present disclosure may be embodied in the form of software products, and the software products may be stored in a non-volatile storage medium (which may be CD-ROM, U disk, mobile hard disk, etc.) or on the network, including several instructions to cause a computing device (which may be a personal computer, a server, a terminal device, or a network device, etc.) to execute the method according to an embodiment of the present disclosure.

In an exemplary embodiment of the present disclosure, there is also provided a computer-readable storage medium on which a program product capable of implementing the above-described method of the present specification is stored. In some possible embodiments, aspects of the present disclosure may also be implemented in the form of a program product comprising program code, and when the program product is executed on a terminal device, the program code is used to cause the terminal device to perform the steps according to various exemplary embodiments of the present disclosure described in the “DETAILED DESCRIPTION” section above in this specification.

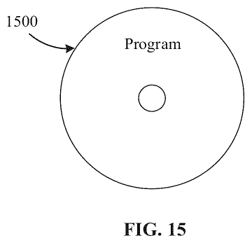

Referring to FIG. 15, a program product 1500 for implementing the above method according to an embodiment of the present disclosure is described, which can adopt a portable compact disk read only memory (CD-ROM) and include program codes, and can be executed on a terminal device such as a personal computer. However, the program product of the present disclosure is not limited thereto, and in this document, a readable storage medium may be any tangible medium that contains or stores a program that can be used by or in conjunction with an instruction execution system, apparatus, or device.

The program product may employ any combination of one or more readable media. The readable medium may be a readable signal medium or a readable storage medium. The readable storage medium may be, for example, but not limited to, an electrical, magnetic, optical, electromagnetic, infrared, or semiconductor system, apparatus or device, or a combination of any of the above. More specific examples (non-exhaustive list) of readable storage media include: electrical connections with one or more wires, portable disks, hard disks, random access memory (RAM), read only memory (ROM), erasable programmable read only memory (EPROM or flash memory), optical fiber, portable compact disk read only memory (CD-ROM), optical storage devices, magnetic storage devices, or any suitable combination of the foregoing.

A computer readable signal medium may include a propagated data signal in baseband or as part of a carrier wave with readable program code embodied thereon. Such propagated data signals may take a variety of forms, including but not limited to electromagnetic signals, optical signals, or any suitable combination of the foregoing. A readable signal medium can also be any readable medium, other than the readable storage medium, that can transmit, propagate, or transport the program for use by or in connection with the instruction execution system, apparatus, or device.

Program code embodied on a readable medium may be transmitted using any suitable medium, including but not limited to wireless, wireline, optical fiber cable, RF, etc., or any suitable combination of the foregoing.

Program code for carrying out operations of the present disclosure may be written in any combination of one or more programming languages, including object-oriented programming languages-such as Java, C++, etc., as well as conventional procedural programming language—such as the “C” language or similar programming language. The program code may execute entirely on the user computing device, partly on the user device, as a stand-alone software package, partly on the user computing device and partly on a remote computing device, or entirely on the remote computing device or server. Where remote computing devices are involved, the remote computing devices may be connected to the user computing device over any kind of network, including a local area network (LAN) or wide area network (WAN), or may be connected to an external computing device (e.g., connecting through the Internet using an Internet service provider).

Other embodiments of the present disclosure will readily suggest themselves to those skilled in the art upon consideration of the specification and practice of the invention disclosed herein. This disclosure is intended to cover any variations, uses, or adaptations of the present disclosure that follow the general principles of the present disclosure and include common knowledge or techniques in the technical field not disclosed by the present disclosure. The specification and examples are to be regarded as exemplary only, with the true scope and spirit of the disclosure being indicated by the claims.

1. A voice control method, applied in a display terminal, the method comprising:
obtaining user voice information, and creating a voice control relationship between the user and a target voice control window based on the user voice information, wherein the target voice control window is one of multiple voice control windows displayed in the display terminal; and
converting the user voice information into a control instruction, and executing control content corresponding to the control instruction in the target voice control window.

2. The voice control method according to claim 1, wherein the creating the voice control relationship between the user and the target voice control window based on the user voice information, comprises:
determining voice features corresponding to the user voice information, and determining a number N of users based on the voice features;
in a case that the number N of users is less than or equal to a preset number M, displaying N voice control windows in the display terminal; and
creating the voice control relationship between the N users and the N voice control windows, respectively.

3. The voice control method according to claim 2, wherein the preset number M is determined based on a size of the display terminal or a target size corresponding to the display terminal.

4. The voice control method according to claim 2, further comprising:
in a case that the number N of users is greater than the preset number M, selecting, from the N users, M target users according to a preset rule, wherein the preset rule comprises: detecting a distance between the user and the display terminal, and selecting the M target users from the N users according to the distance; or, selecting the M target users from the N users according to the voice features, wherein the voice features comprises volume; and
creating the voice control relationship between the M target users and the M voice control windows, respectively.

5. The voice control method according to claim 2, further comprising:
in a case that the number N of users is less than or equal to the preset number M, obtaining relative position information of the users relative to the display terminal; and
creating, according to the relative position information, the voice control relationship between the N users and the N voice control windows, respectively.

6. The voice control method according to claim 2, wherein the creating the voice control relationship between the user and the target voice control window based on the user voice information, comprises:
displaying M voice control windows in the display terminal, and assigning a window identifier to each voice control window;
in a case that the user voice information comprises information matching the window identifier, determining the target voice control window from the M voice control windows according to the user voice information; and
creating the voice control relationship between the user corresponding to the user voice information and the target voice control window.

7. The voice control method according to claim 6, wherein the information matching the window identifier comprises position information of the user; and
the determining the target voice control window from the M voice control windows according to the user voice information, comprises:
determining the target voice control window from the M voice control windows according to the position information.

8. The voice control method according to claim 6, further comprising:
in a case that the user voice information does not comprise information matching the window identifier, obtaining relative position information of the user relative to the display terminal; and
creating the voice control relationship between the user corresponding to the user voice information and the target voice control window according to the relative position information.

9. The voice control method according to claim 2, wherein the creating the voice control relationship between the user and the target voice control window based on the user voice information, comprises:
displaying M voice control windows in the display terminal;
determining preset voiceprint information corresponding to the M voice control windows respectively;
performing voiceprint recognition on the user voice information to obtain user voiceprint information, and in a case that the user voiceprint information matching preset voiceprint information, determining the voice control window corresponding to the preset voiceprint information as the target voice control window; and
creating the voice control relationship between the user corresponding to the user voiceprint information and the target voice control window.

10. The voice control method according to claim 1, wherein the obtaining user voice information comprises:
obtaining original user voice information, and decoding the original user voice information to obtain user voice audio; and
performing text recognition on the user voice audio to obtain the user voice information.

11. The voice control method according to claim 1, wherein the control instruction comprises an execution action and execution content; and
the executing the control content corresponding to the control instruction in the target voice control window, comprises:
executing the execution content in the target voice control window based on the execution action.

12. The voice control method according to claim 1, further comprising:
in a case that the user voice information corresponding to the user is not obtained within a preset time period, displaying default content in the target voice control window.

13. The voice control method according to claim 1, wherein the user voice information comprises near-field voice information and/or far-field voice information.

14. (canceled)

15. An electronic device, comprising:
a processor; and
a memory, configured to store executable instructions for the processor;
wherein the processor is configured to execute the executable instructions to perform:
obtaining user voice information, and creating a voice control relationship between the user and a target voice control window based on the user voice information, wherein the target voice control window is one of multiple voice control windows displayed in the display terminal; and
converting the user voice information into a control instruction, and executing control content corresponding to the control instruction in the target voice control window.

16. A computer non-transitory readable storage medium on which a computer program is stored, wherein when the computer program is executed by a processor, a voice control method is implemented, comprising:
obtaining user voice information, and creating a voice control relationship between the user and a target voice control window based on the user voice information, wherein the target voice control window is one of multiple voice control windows displayed in the display terminal; and
converting the user voice information into a control instruction, and executing control content corresponding to the control instruction in the target voice control window.

17. The electronic device according to claim 15, wherein the creating the voice control relationship between the user and the target voice control window based on the user voice information, comprises:
determining voice features corresponding to the user voice information, and determining a number N of users based on the voice features;
in a case that the number N of users is less than or equal to a preset number M, displaying N voice control windows in the display terminal; and
creating the voice control relationship between the N users and the N voice control windows, respectively.

18. The electronic device according to claim 17, wherein the preset number M is determined based on a size of the display terminal or a target size corresponding to the display terminal.

19. The electronic device according to claim 17, wherein the processor is further caused to perform:
in a case that the number N of users is greater than the preset number M, selecting, from the N users, M target users according to a preset rule, wherein the preset rule comprises: detecting a distance between the user and the display terminal, and selecting the M target users from the N users according to the distance; or, selecting the M target users from the N users according to the voice features, wherein the voice features comprises volume; and
creating the voice control relationship between the M target users and the M voice control windows, respectively.

20. The electronic device according to claim 17, wherein the processor is further caused to perform:
in a case that the number N of users is less than or equal to the preset number M, obtaining relative position information of the users relative to the display terminal; and
creating, according to the relative position information, the voice control relationship between the N users and the N voice control windows, respectively.

21. The electronic device according to claim 17, wherein the creating the voice control relationship between the user and the target voice control window based on the user voice information, comprises:
displaying M voice control windows in the display terminal, and assigning a window identifier to each voice control window;
in a case that the user voice information comprises information matching the window identifier, determining the target voice control window from the M voice control windows according to the user voice information; and
creating the voice control relationship between the user corresponding to the user voice information and the target voice control window.
